(19) United States
(12) Patent Application Publication
(10) Pub. No.: US 2004/0197457 A1
(43) Pub. Date: Oct. 7, 2004

(54) Method for producing a food preparation, composed of a liquid or alcohol moistened mixture of gelatinizers and sugar varieties, produced with animal and/or microbial material, said mixture having gelatinizing and/or thickening characteristics in cold, watery solutions, emulsions and water-containing foods, and product produced therewith

(75) Inventors: Helmuth Fuchs, Melle (DE); Christian Fretter, Bad Salzuflen (DE); Marlise Schwechheimer, Bielefeld (DE); Thaddaus Losos, Bielefeld (DE); Sabine Lieker, Bielefeld (DE)

Correspondence Address: VENABLE, BAETJER, HOWARD AND CIVILETTI, LLP, P.O. BOX 34385, WASHINGTON, DC, 20043-9998, US

(73) Assignee: Dr. August Oetker Nahrungsmittel KG, Bielefeld (DE)

(21) Appl. No.: 10/772,442

(22) Filed: Feb. 6, 2004

(30) Foreign Application Priority Data
Apr. 4, 2003 (DE) 103 15 614.3

(51) Int. Cl. A23L 1/05

(52) U.S. Cl. 426/573

(57) ABSTRACT

The present invention relates to a method for producing a food preparation, characterized in that a product is created by mixing together ground gelatin with saccharose or other sugar varieties, moistened with alcohol and/or liquid, at a ratio of 1:1 to 1:15. This product dissolves or swells without problem in watery solutions, emulsions or water-containing food items at temperatures above 4° C. or in water-containing food items and subsequently forms a gel or thickens during a prolonged exposure at an environmental temperature below 35° C.

### CROSS-REFERENCE TO RELATED APPLICATION

This application claims the priority of German Priority Application with Serial No 103 15 614.3, filed on May Apr. 4, 2003, the subject matter of which is incorporated herein by reference.

### BACKGROUND OF THE INVENTION

The present invention relates to a method for creating a product by mixing comminuted, ground gelatinizing and/or thickening agents, for example gelatin or the like, having an ideal grain size of less than 0.8 mm, with moistened saccharose or other sugar varieties, wherein this product dissolves and/or swells without problems in cold, watery solutions, emulsions and water-containing foods such as milk, yoghurt, whipping cream, sour cream and the like and subsequently forms a gel and/or thickened product following a prolonged time of exposure.

Ground gelatin or gelatin or gelatin in the form of a leaf has traditionally been used in households for preparing cream pies, red fruit jellies, jellos and similar products. The commercially available gelatin must initially be allowed to swell for a longer period of time in a small amount of cold water under household conditions and must subsequently be heated above its melting point. The gelatin dissolved in this way is then added to the food to be thickened and/or gelatinized.

For some consumers this processing step represents a problem because it is extremely time consuming. The uniform folding in of the dissolved gelatin is made more difficult in that the food item to be thickened as well as the gelatin must have approximately the same temperature. If the gelatin solution is too warm, it can lead to the liquefying of heat-sensitive foods such as whipped cream. If the dissolved gelatin is too cold, meaning just below the gelatinizing point, it solidifies immediately when it is folded into the food items having a temperature below the melting point of the gelatin. As a result, small to large clumps or gelatinous threads form, which unpleasantly affect the taste inside the mouth.

In addition to its traditional use in the household, gelatin is also used in baking mixtures, in particular as foundation for whipping cream and cream. These foundations as a rule are composed of one part ground gelatin and at least five parts of a suitable separating agent. To be sure, mixtures of this type can be dissolved through heavy stirring and by slowly adding warm water at a temperature of approximately 30° C. However, this can generally be achieved only by using correspondingly fast moving stirring apparatuses, i.e. of the variety generally used in commercial operations. A pre-swelling in water is required in this case as well before the actual food item to be gelatinized—as a rule whipping cream—is added in the whipped form. Also, the use of water at a temperature of less than 35° C. is not possible in this case since the mixture of gelatin and separating agent has a tendency to clump.

To be sure, commercially available products with names such as “Instant Gelatin,” produced on a gelatin/maltodextrin base, can be poured mostly without clumping directly into the liquid cream and can be whipped up together with the cream. However, low-blooming gelatin is generally used for producing the instant gelatin, so that only a very weak gel can form. Even increasing the amount that is metered-in will not result in a comparable gel firmness.

Multiple attempts have been made to remedy this problem and simplify the use of gelatin. German Patent 44 24 866 describes a method for which the sugar is initially mixed with oil and pectin is subsequently added. The disadvantage of this method is that these ingredients do not combine homogeneously but only become attached to each other. In addition, a mixture produced in this way cannot be used for the preparation of transparent food items because this results in clouding or fat drops that are visible on the surface.

### SUMMARY OF THE INVENTION

Thus, it is the object of the invention to introduce a gelatinizing agent (for example gelatin), obtained from animal or microbial material, into a mixture in such a way that this gelatinizing agent forms the corresponding gel and/or thickened product without pre-swelling and heating during a uniform mixing with the food item to be thickened or gelatinized (for example when directly whipped up with the liquid cream).

This object is solved according to the invention with the characterizing section of claims 1, 2, 3 and 10. Advantageous modifications follow from the dependent claims.

If an attempt is made to simply mix gelatinizing agents such as gelatin, obtained from animal or microbial material, with carrier materials in the form of different sugar varieties, a product is obtained that cannot be mixed with cold, watery solutions, cold emulsions or cold water-containing foods without forming clumps. Jello products typically cannot be produced by using high-blooming gelatin.

Thus, when using a micro-ground gelatin that attaches itself with the aid of water and/or alcohols to saccharose or other sugar varieties, it was a surprise to find out that a pourable product is obtained that gelatinizes directly in cold watery solutions, cold emulsions or cold water-containing food items. The micro-ground gelatin consequently does not form a large clump that cannot be dissolved. Rather, agglomerate-type products with pores are formed into which liquid can penetrate, thus preserving the advantages of the micro-ground gelatin, such as swelling and the ability to dissolve. Clear gels can be obtained only in this way if clear liquids are used.

### DETAILED DESCRIPTION OF THE PREFERRED EMBODIMENTS

The invention is explained in further detail with the aid of the following examples:

### EXAMPLE 1

A mixing apparatus contains a starting batch of 7 kg saccharose (grain size 0.4 mm to 1 mm) to which 140 ml water are added to produce a uniformly moistened mixture. With a sifting device (mesh width 0.5 mm), 1 kg ground gelatin is sifted into the running mixing apparatus and is mixed homogeneously with the pre-moistened sugar of the starting batch.

### EXAMPLE 2

A starting batch of 4 kg saccharose (grain size 0.4 mm to 1 mm) is placed into a mixing apparatus, 140 ml water are added and a moistened mixture is produced from this. A previously produced mixture of 1 kg ground gelatin and 3 kg dextrose is then slowly metered into the running mixing apparatus with a screw-type metering mechanism, wherein a uniformly mixed, pourable product is created.

### EXAMPLE 3

A starting batch of 7 kg fructose (grains size 0.4 mm to 1 mm) is placed into a mixing apparatus, to which the amount of 15 g glycerin is added to produce a uniformly moistened mixture. A previously produced mixture of 2 kg ground gelatin and 1 kg dextrose is slowly metered into the running mixing apparatus with a screw-type metering mechanism, wherein a uniformly mixed, pourable product is created.

1. A method for producing a food preparation that can be easily dissolved and/or swells easily in water, watery solutions, emulsions or water-containing food items at temperatures above 4° C. and contains crystalline, animal and/or microbial gelatinizing agents and sugar varieties, said food preparation having gelatinizing and/or thickening characteristics where the gelatinizing agent attaches itself with the aid of water and/or alcohols as a thin layer to the surface of the sugar varieties, characterized by the following steps:
a. Finely ground gelatinizing and/or thickening agents of animal and/or microbial origin are mixed uniformly with a sugar variety or a mixture of different sugar varieties at a predetermined ratio.
b. Different sugar varieties are moistened inside a separate mixing apparatus by mixing together 0.01% to 10% water (preferably 3%) and/or mono- or multivalent alcohols (preferably 0.2%).
c. The moistened sugar varieties from step b. are then homogeneously mixed with the mixture produced in step a.

2. The method according to claim 1, characterized in that
a. different sugar varieties are moistened in a stirring apparatus by mixing together 0.01% to 10% water (preferably 3%) and/or mono- or multivalent alcohols (preferably 0.2%);
b. finely ground gelatinizing and/or thickening agents of an animal and/or microbial origin are homogeneously mixed with the mixture produced in processing step a.

3. The method according to claim 1, characterized in that gelatinizing and/or thickening agents and sugar varieties are present at a ratio of 1:1 to 1:15.

4. The method according to claim 1, characterized in that predetermined amounts of fruit acids and/or fruit powders and/or aromatic agents and/or spices and/or coloring agents and/or sweeteners are added to the mixture according to claim 1.

5. The method according to claim 1, characterized in that the sugar varieties comprise all mono-, di- and polysaccharides as well as their monohydrates and alcohols which are registered as food items.

6. The method according to claim 1, characterized in that the sugar varieties have a grain spectrum exceeding 0.1 mm.

7. The method according to claim 1, characterized in that different animal and/or microbially produced gelatinizing and/or thickening agents are mixed together at a predetermined ratio.

8. The method according to claim 1, characterized in that the gelatinizing agent and/or the thickening agent obtained from animal and/or microbial material has a grain size of less than 2 mm.

9. The method according to claim 1, characterized in that preservatives and/or antioxidants are added to stabilize the mixture.

10. The food preparation produced according to claim 1.

11. The method according to claim 2, characterized in that gelatinizing and/or thickening agents and sugar varieties are present at a ratio of 1:1 to 1:15.

12. The method according to claim 2, characterized in that predetermined amounts of fruit acids and/or fruit powders and/or aromatic agents and/or spices and/or coloring agents and/or sweeteners are added to the mixture according to claim 1.

13. The method according to claim 2, characterized in that the sugar varieties comprise all mono-, di- and polysaccharides as well as their monohydrates and alcohols which are registered as food items.

14. The method according to claim 2, characterized in that the sugar varieties have a grain spectrum exceeding 0.1 mm.

15. The method according to claim 2, characterized in that different animal and/or microbially produced gelatinizing and/or thickening agents are mixed together at a predetermined ratio.

16. The method according to claim 2, characterized in that the gelatinizing agent and/or the thickening agent obtained from animal and/or microbial material has a grain size of less than 2 mm.

17. The method according to claim 3, characterized in that predetermined amounts of fruit acids and/or fruit powders and/or aromatic agents and/or spices and/or coloring agents and/or sweeteners are added to the mixture according to claim 1.
